(19) United States
(12) Patent Application Publication
(10) Pub. No.: US 2023/0079441 A1
(43) Pub. Date: Mar. 16, 2023

(54) Apparatus and Method of Re-Ordering Drawing Blocks on a Slide of a User Interface Canvas

(71) Applicant: Pitch Software GmbH, Berlin (DE)

(72) Inventors: Maria Geller, Tauplitz (AT); Jeremy Vuillermet, Saint Augustin (FR); Joanne Cheng, Berlin (DE); Adam Renklint, Berlin (DE); Kevin Cannon, Berlin (DE)

(21) Appl. No.: 17/798,486

(22) PCT Filed: Feb. 10, 2021
(86) PCT No.: PCT/EP2021/053222

§ 371 Date: Aug. 9, 2022

(30) Foreign Application Priority Data
Feb. 10, 2020 (LU) LU101638
Mar. 16, 2020 (LU) LU101696

(51) Int. Cl. G06T 11/00; G06T 7/33

(52) U.S. Cl. CPC G06T 11/00; G06T 7/33; G06T 2200/24

(57) ABSTRACT

A computer-implemented method of re-ordering one or more of a plurality of drawing blocks on a slide of a user interface canvas is disclosed. The user interface canvas is stored in a graphics memory and displayed on an interface screen. The method comprises analyzing using a graphical processor memory elements in the graphics memory to identify a plurality of anchor positions for the plurality of drawing blocks and the slide, storing the identified anchor positions in the graphics memory, analyzing the identified and stored anchor positions to identify common elements from among the identified and stored anchor positions, and reordering at least one of the plurality of drawing blocks to a different position on the slide such that at least one of the anchor position of the re-ordered drawing block moves to a common element from among the identified and stored anchor positions.

### FIELD OF THE INVENTION

The invention relates to an apparatus and system for re-arranging drawing blocks on a slide and displaying the slide.

### BACKGROUND OF THE INVENTION

Effective communication with both internal and external audiences is nowadays extremely important and electronic presentations using, for example, Microsoft's PowerPoint Software or Apple's Keynote software are often used for communicating to efficiently provide information to an audience. This software creates a canvas on which the user can create slides and, on the slides, drawing blocks. The drawing blocks include images and texts and can be individually formatted.

Such presentations can take a long time to prepare and to format correctly. A presentation may require regular updating (depending on its content) and new information may need to be added. This updating and addition may require re-arrangement of the text on the slides which can lead to the need to re-arrange the drawing blocks on the slide. This is time-consuming for a user to perform and there is therefore a need to establish an improved method for amending and reformatting the slides.

There are several patent documents known that describe a computer-implemented method for the re-arrangement of objects in a graphics editing program. For example, U.S. Pat. No. 8,659,621 (Stiglitz et al, assigned to Apple) teaches a method which involves the scanning of a drawing area of a graphics editing program to identify drawing objects and identifying the overlap of the drawing objects so as to eliminate the overlap.

US Patent Application US 2017/285919 (Hatfield et al, assigned to Microsoft) teaches a method of creation of content on a drawing canvas in a graphics editing program using a stencil as a method of free-form inking.

US Patent Application US 2011/173552 A1 (Ikegami, assigned to NEC) discloses a usability evaluation system and method for a presentation system. The system and method comprise an automatic evaluating device for evaluating the appropriateness of a layout of elements in the presentation system. Evaluating the appropriateness of the elements is done by checking a position or a size of the elements relative to each other as displayed in the presentation system.

US Patent Application US 2016/189404 A1 (Edge et al, assigned to Microsoft) discloses a method for selecting and editing elements across multiple slides. The method obtains multiple visuals each including visual elements. The elements may be grouped and synchronized based on similarities of an attribute among the elements. The visual elements are presented to a user for evaluation. The user selects and changes the element. These changes by the user are propagated to other visual elements that belong to the same group of the visual element.

European Patent Application EP 0 848 351 A2 (Richard Gartland, assigned to Adobe Systems Inc.) discloses a method and apparatus for repositioning elements on a canvas in response to a user requesting to change a layout and/or size of the canvas. The method includes detecting the elements on the canvas. The method further includes receiving the user request to change the layout or size of the canvas for display of the element. Using the detected elements and the user request, the method realigns and resizes the elements according to the user request. The method disclosed allows the automatic realignment and/or resizing of the elements on the canvas for an improved visual presentation of the elements to the user after changing the layout or size of the canvas by the user. The elements are realigned relative to their position on the canvas. A realignment of the elements relative to each other is not, however, disclosed.

### SUMMARY OF THE INVENTION

A computer-implemented method of re-ordering one or more of a plurality of drawing blocks on a slide of a user interface canvas is disclosed. The data relating to the user interface canvas is stored as memory elements in a graphics memory and can be used to render the user interface canvas for display on an interface screen. The method comprises analyzing (using a graphical processor) the memory elements in the graphics memory to identify a plurality of anchor positions for the plurality of drawing blocks and for the slide. The identified anchor positions are stored in the graphical memory. Subsequently the identified and stored anchor positions are analyzed to identify common elements from among the identified and stored anchor positions, whereby said identified common elements are stored in the graphics memory. Finally, at least one of the drawing blocks with similar elements is moved to a different position on the slide such that at least one of the anchor positions of the re-ordered drawing block moves to one of the identified common elements. The method enables to align efficiently the drawing blocks on the slide of the user interface canvas relative to each other.

There are various ways of defining the anchor positions. For example, the anchor position could be one or more of a left edge, a right edge, a top edge, a bottom edge, a vertical center or a horizontal center. Similar ones of the drawing blocks can be identified from either commonly sized images or identical text elements, e.g., font name, font size, font color.

The method can involve grouping similar ones of the drawing blocks or swapping similar ones of the drawing blocks.

The method enables the re-ordering of different sized blocks by identifying the anchor positions. The methods known in the prior art have relied on being able to swap same-sized blocks.

An apparatus for re-ordering drawing blocks on a slide of a user interface canvas is also disclosed. The apparatus comprises a graphics memory, a display device, and a graphical processor for performing the method.

### DESCRIPTION OF THE FIGURES

FIG. 1 shows an overview of the system.

FIG. 2 shows an exemplary canvas with a slide.

FIG. 3 shows an exemplary method illustrating the invention.

FIGS. 4A and 4B show a use case of swapping blocks.

FIG. 5 shows a use case of aligning blocks.

FIG. 6 shows a use case of text wrapping of text blocks.

FIG. 7 shows a method for identifying common elements.

FIG. 8 shows the movement of a drawing block.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

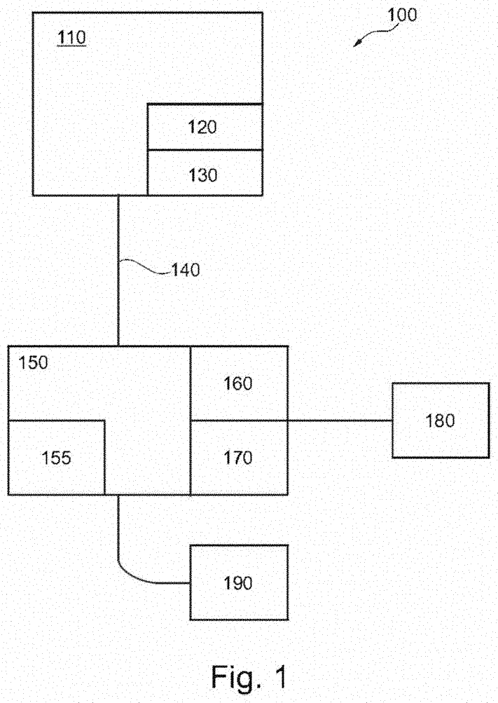

FIG. 1 shows an overview of an example of a system for implementing the method described in this document. It will be appreciated that the arrangement of the hardware elements shown in this figure is somewhat arbitrary and that they may be changed, re-arranged and added to. For example, the system is shown with a client and a server cooperating together, but it will be appreciated that the method could also run on a stand-alone system without a network connection.

The system 100 comprises a server 110 having a server processor 120 on which a program 130 is running which implements the method. The server 110 is connected through a network 140 to one or more client computers 150. The client computer 150 has at least a graphical processor 160 connected to a graphics memory 170 in which the graphical data is stored in memory elements. The graphical processor 160 and the graphics memory 170 collaborate to enable processing of graphical data. The graphical data forming a user interface canvas is displayed on a display unit 180 connected to the client computer 150. A pointer 190 or similar device, such as a touch pen, touch pad, cursor, mouse, is connected to the client computer 150. The pointer 190 is used by the user to point to and select one or more elements on the display unit 180. The pointer 190 sends the coordinates to the graphical processor 160 which is able to identify the position on the display unit 180 and sends a signal to the display unit 180 to display an appropriate symbol at the position on the display unit 180. The graphical processor 160 is able to access data in the graphics memory 170 and thereby identify any features stored in the graphics memory 170 at the position of the pointer 190. A signal is generated by the graphical processor 160 which may be then either processed in the server processer 120 or at a local processor 155.

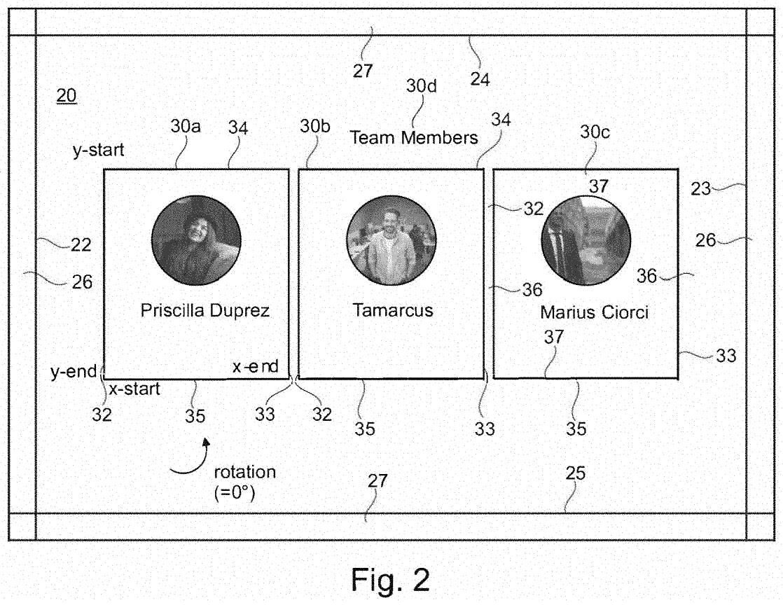

FIG. 2 shows an example of a canvas displayed on the display unit 180 and produced from the graphical processor 160 using data stored in the graphics memory 170 and showing a number of drawing blocks 30a-d on the slide 20. Graphics data relating to the size and position of the drawing blocks 30a-d is stored in the graphics memory 170. In one exemplary aspect of the invention, this is done by storing coordinates relating to the edges 35 of the drawing block 30a-d. The description of the block would therefore have the following form

[x-start;x-end;y-start;y-end;rotation]

The positions of x-start, x-end, y-start and y-end are shown with respect to the drawing block 30a. The rotation is an optional element and will have a default value of 0°. In the rest of this description the value of the rotation of the drawing blocks 30a-d will be ignored. This method of storage reduces substantially the requirements for storage space in the graphics memory 170 and enables efficient processing for the method as will now be explained. It is not necessary, for example, to store data for all of the pixels relating to the drawing blocks 30a-d in the graphics memory, but only the start and end points of two dimensions of the drawing blocks 30a-d, i.e., x-start; x-end; y-start; y-end.

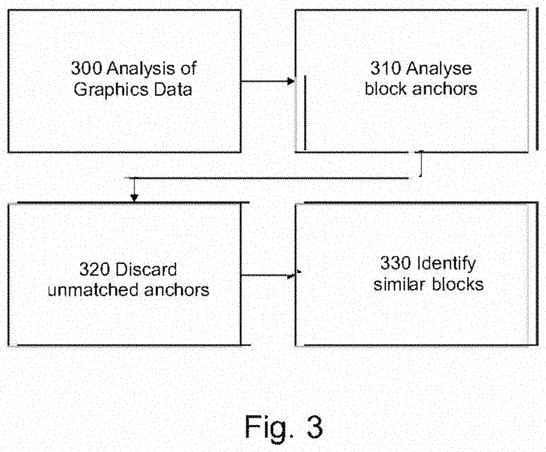

FIG. 3 shows an example of the method of the invention, which is run, for example, in the graphical processor 160. In a first step 300, the graphics data in the graphics memory 170 will be analyzed in step 300 to determine so-called block anchors. Six block anchors are determined for the drawing blocks 30a-c and are shown in FIG. 2:
Left edge 32
Right edge 33
Top edge 34
Bottom edge 35
Center Horizontal 36
Center Vertical 37

These are shown for simplicity on the drawing block 30c but will be equally applicable to other ones of the drawing blocks 30a and 30b as well as for the drawing block 30d.

In addition, six similar slide anchors for the slide 20 as a whole are defined and are also shown in FIG. 2. Four of the slide anchors (22, 23, 24 and 25) for the slide 20 represent margins defining a border about the edge of the slide 20 in which none of the drawing blocks 30a-d should be placed. The other two slide anchors are the center horizontal 26 and the center vertical 27.

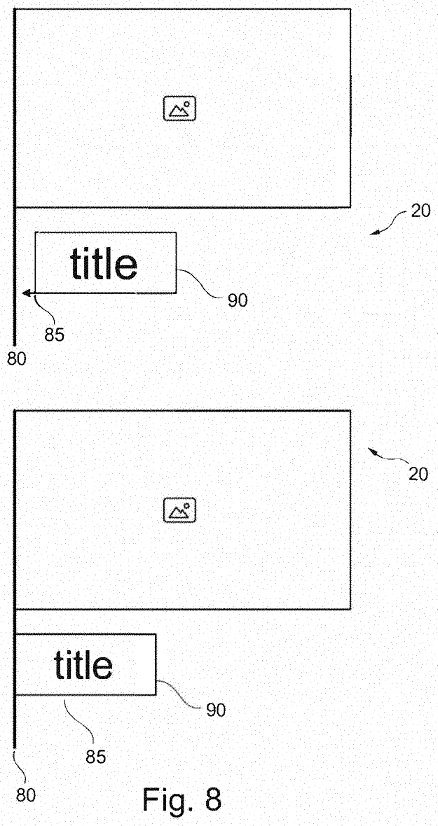

In the following step 310, the block anchors 32-37 for all of the drawing blocks 30a-d and the slide anchors 22-27 are analyzed to determine their common elements. These common elements comprise similar or identical values among the analyzed slide anchors 22-27 and the analyzed block anchors 32-37. The analyzed slide anchors 22-27 and the analyzed block anchors 32-37 are commonly termed “stored anchor positions” 22-27, 32-37, and their values are stored in the graphics memory 170. The analyzing of the common elements is shown in more detail in FIG. 8. The common elements, comprising the plurality of identified common anchor positions 22-27, 32-37, are used for identifying, by the graphical processor 160, those slide anchors 22-27 and/or block anchors 32-37 which match with each other. The matching is determined by those slide anchors 22-27 and/or block anchors 32-37 that have the same or similar values, as will be explained below in step 330. It will be noted that this matching of the anchors can be between the block anchors 22-27 of different drawing blocks 30a-d and/or between one or more of the block anchors 32-37 and one or more of the slide anchors 22-27. It will also be noted that this matching based on the common elements only requires the calculation of the values for the common anchor positions 22-27, 32-37 of the analyzed slide anchors 22-27 and the analyzed block anchors 32-37 for the alignment of the drawing blocks 30a-d.

The unmatched ones of the block anchors 32-37 and the slide anchors 22-27 can then in step 320 be ignored. The unmatched anchors 22-27, 32-37 are not required for the rest of the method and thus do not need to be stored in the graphics memory 170 or processed to save computing resources.

Finally, in step 330, the drawing blocks 30a-d are analyzed to determine which ones of the drawing blocks 30a-d are similar. The analysis is initially carried out by comparing the drawing blocks 30a-d to see if any of the drawing blocks 30a-d are of a similar size. The graphical data representing the drawing blocks 30a-d is stored in the memory elements in the graphical memory 170 and can be fetched from the graphical memory 170 for process in the graphical processor 160.

For example, suppose there are two (or more) images of a similar size in two (or more) of the drawing blocks 30a-d, then the analysis of the graphics data will determine that the two (or more) drawing blocks 30a-d, containing the similar-sized images, are similar. In another example, suppose that there are two (or more) drawing blocks 30a-d which have text. The two (or more) drawing blocks 30a-d will be considered to be similar if the text used in each of the two (or more) blocks 30a-d has the same font and the same color.

This means that the drawing blocks 30a, 30b and 30c in FIG. 2 will be considered to be similar because the drawing blocks 30a, 30b and 30c have images of similar size and text with same size font and color. The drawing block 30d will not be considered to be similar with any of the drawing blocks 30a, 30b and 30c because there is no image, and the text is of a different font size (but of the same color and font)

There can be other methods of determining similarity. Consider again the drawing blocks 30a-d in FIG. 2 a variation of the method will identify in step 330 that the drawing blocks 30a-c are similar because their top edge 34 and their bottom edge 35 have identical values (common elements of the block anchors) and are thus similar. On the other hand, the drawing block 30d in the same FIG. 2 has no common element with any of the blocks 30a-c, i.e., none of the block anchors match with any of the block anchors of the blocks 30a-c. The drawing block 30d is therefore not similar.

It will be appreciated that the identifying of the anchor positions 22-27, 32-37 for the plurality of drawing blocks 30a-d, 500a-d and for the slide 20 is carried out by the analyzing of the values stored in the memory elements in the graphics memory 170. Analyzing the memory elements in the graphics processing memory 170 is done to identify common elements from among the identified and stored values for the anchor positions 22-27, 32-37 for the plurality of drawing blocks 30a-d, 500a-d. Analyzing the memory elements comprises comparing and identifying the common values for the anchor positions 22-27, 32-37 in the graphics processing memory 170. The reordering of the drawing blocks 30a-d, 500a-d is done, unlike in the prior art, using the values of the common elements of the drawing blocks 30a-d, 500a-d and subsequently moving at least one of the drawing blocks 30a-d, 500a-d to at least one of the identified anchor positions 22-27, 32-37 of a further one of the plurality of the drawing blocks 30a-d, 500a-d.

For example, the common elements might be two drawing blocks 30 which both comprise a left edge 32 having similar or identical values of the x-coordinates. In this case, the reordering of the drawing blocks 30a-d, 500a-d comprises moving one of the plurality of the drawing blocks 30a-d, 500a-d to one of the identified common elements along the identical or similar x-coordinates of the plurality of the drawing blocks 30a-d, 500a-d. This could be done, for example, by replacing the stored values of the current x-coordinate with values of the x-coordinates of the common elements.

Further examples of the method will be described in below examples.

The system described in this document enables a number of use cases that will now be described.

### Block Swapping

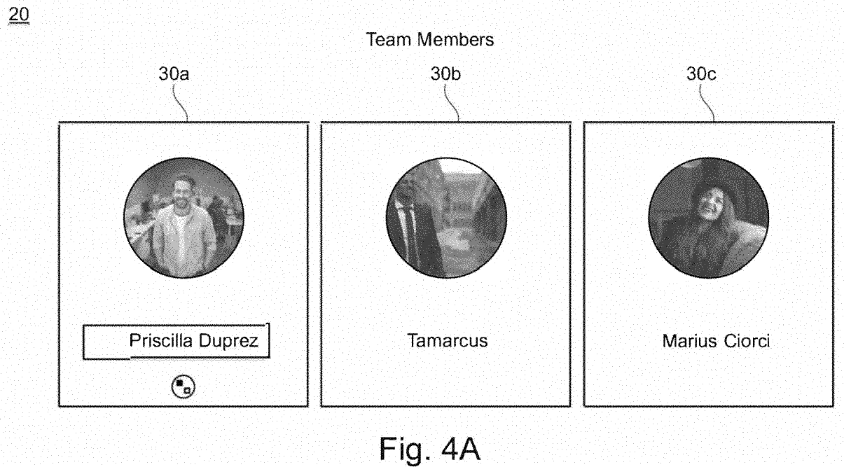

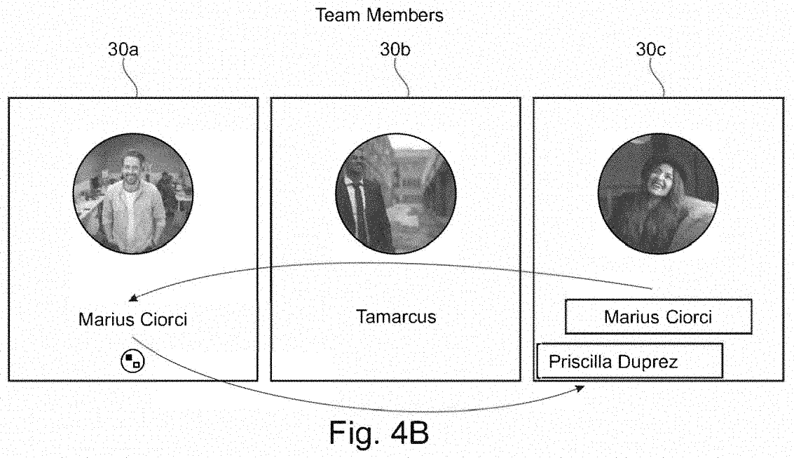

Suppose that the user wishes to swap two of the (similar) drawing blocks 30a-c with each other. The drawing blocks 30a-c were identified as being similar in step 330 and can thus be swapped with each other. This swapping can be done in several ways. In one way, which is not limiting the invention, a first one 30a of the drawing blocks 30a-c to be moved is highlighted, for example by clicking on an icon in or near one of the drawings block 30a-c, and the other similar ones of the drawing blocks 30a-c on the slide 20 will be highlighted, as is shown in FIG. 4A. The user can as a result select the chosen one of the drawing blocks 30a-c for swapping and the swap is implemented between the first one of the drawing blocks 30a-c and one of the similar ones of the drawing blocks 30a-d. This swap is not only efficient for the use, but also requires little processing by the graphical processor 160 since the graphical processor 160 only needs to process the changed graphic data to re-render the image of the slide 20 with the swapped drawing blocks 30a-c on the display 180. The method of this document enables the calculation of the new position of the drawing blocks 30a-c to be carried out quickly since all of the position data can be re-used for the swapped drawing blocks 30a-c.

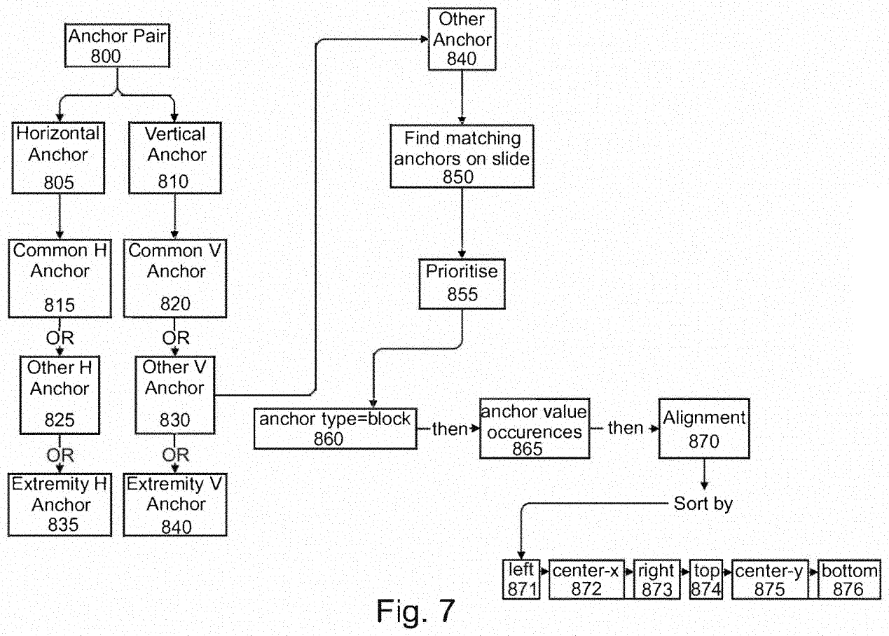

Once the two drawing blocks 30a-c that need to be swapped (called the candidate blocks) are determined in step 330, the method of this document is used to find an anchor pair of each of the two blocks 30a-c. The anchor pair is defined as [horizontal-anchor, vertical-anchor] and is a way to describe a position of one of the blocks 30a-c in a two-dimensional space using anchor lines. The rules relating to this method are shown in detail in FIG. 7. The anchor pair 800 has both a horizontal anchor 805 and a vertical anchor 810.

In the next step, the blocks 30a-c are compared to determine those anchor pairs (i.e., common elements) matching between different ones of the blocks 30a-c for swapping. There are a number of possible methods of determining the matching anchor pairs which are shown in blocks 815-840. The table below shows the priority rules applied to determine the matching anchor pair.

The system tries each of the priority rules set out in the method until one vertical anchor and one horizontal anchor for the different ones of the blocks 30a-c are determined. It is possible that a particular method only finds a matching anchor on one single axis (i.e., either x-axis or y-axis). The final priority rule is called extremity anchor and will always find two anchors on both the x-axis and the y-axis. The final priority rule is used as a default anchor paid in case the other priority rules were unable to determine a better anchor pair for the candidate blocks.

As indicated in the table, the three priority rules are tested in this order: common anchors between the two candidate blocks, other anchors on the slide, extremity anchors between the two candidate blocks. The three priority rules are explained in the following section.

| Anchor Type | Horizontal | Vertical |
|---|---|---|
| Common | nil | 0.6 |
| Other | nil | nil |
| Extremity | 0.2 | 0.4 |
| Final anchors | =0.2 | =0.6 |

In the above table, a common anchor is defined as an anchor that is shared by the candidate blocks 30a-c to be swapped. This is shown in steps 815 and 820 of FIG. 7. If the two candidate blocks 30a-c are not aligned in any way, i.e., the test in steps 815 and 820 show that there are no common horizontal anchors or vertical anchors, i.e., the result will be null, the method proceeds to the next row of the table (“other”), i.e., to steps 825 and 830. In this step a test is made in step 840 to see if there is a match with any other anchor on the slide or in step 850 with any of the slide anchors 22-27.

If there are only two drawing blocks on the slide or if none of the anchors of any of the drawing blocks match other anchors of the drawing blocks, then proceed to the next row of the table, i.e., steps 835 and 840. An extremity anchor is the last resort and will always yield a value. The leftmost block will use its left coordinate value, the rightmost block will use its right coordinate value, the topmost block will use its top coordinate value and the bottommost block will use its bottom coordinate value. At this point in the analysis of the table, it is known that the drawing blocks are different, i.e., the drawing blocks do not have the same top or left anchor, since no common anchors were found in the first step.

It will be appreciated that a single one of the drawing blocks 30a-c can have more than one of the matching vertical anchors or the matching horizontal anchors. In this case, a priority rule needs to be used as well for matching of the blocks 30a-c, as indicated by step 855. The priority rule prioritizes matching the blocks anchor 32-37 over matching the slide anchors 22-27, as shown in step 860. If that priority rule 860 is not sufficient, then the anchor with the highest number of occurrences (anchor with the same value) in step 865 is used. Finally, if this does not resolve all of the conflicts, then alignment is used in step 870 in which case the blocks are sorted by considering the anchors in the following order: horizontal anchor: left (step 871) over center-x (step 872) over right (step 873) and then vertical anchors: top (step 874) over center-y (step 875) over bottom (step 876).

It is important to note that all these calculations use the graphics memory 170 as storage. While the size of data represented in a slide on the display unit 180 is “human scale”, the usage of a combination of technologies makes it very efficient to store and process large amounts of data in this storage. In the system the data is stored in persistent data structures.

In one aspect of the system, the computer code is implemented in the Clojure programming language. This implementation relies on those techniques to efficiently copy, extend, filter and sort data structure generated by those different steps.

Once the anchor pair of each of the drawing blocks 30a-c is determined, the swapping can occur on the graphical processor 160. The program uses the React JavaScript library for building the user interface and it is possible to only update part of the user interface as opposed to the entire screen using a technique called virtual Document Object Model. React creates an in-memory data cache for the user interface and when there is a change in the user interface, the React library computes the resulting difference and updates the display on the user interface efficiently.

In this example, the coordinates of the drawing blocks 30a-c need to be updated to make the block swap happen. In other words, one of the drawing blocks 30a-c needs to move to the coordinates of another one of the drawing blocks 30a-c. As discussed above, each of the coordinates has a collection of attributes, which are the values in the coordinate system and the alignment (left, center-x, right, top, center-y, bottom). This means that the values of the coordinates of the anchors need to be swapped for the two drawing blocks 30a-c and then the new display rendered using the React library.

The second way of swapping two of the drawing blocks 30a-c is to drag one of the drawing blocks 30a-c to a position close to another one of the drawings blocks 30a-c with which the swap is to occur. This is less efficient on computing resources because of the need to continually recalculate the position of the dragged one of the drawing blocks 30a-c for rendering on the display 180. At a certain threshold point, for example when half of the area of the dragged drawing block is positioned over another one of the drawing blocks 30a-d as can be seen in FIG. 4B, the graphical processor 160 can make the assumption that the drawing blocks are to be swapped and then automatically complete the swap. This threshold point could occur when, for example, 50% of the areas of the dragged drawing block overlaps the drawing block to be swapped. At this point the graphical processor 160 does not continue to calculate the positions of the dragged drawing block, but simply recalculates the position of the dragged drawing block and locates the dragged drawing block in the position of the other drawing block, as described above.

### Alignment

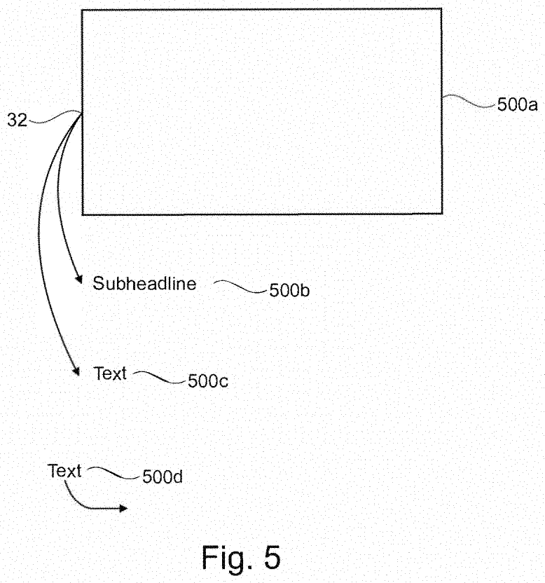

The method and system enable easy alignment of the drawing blocks 500a-d as shown in FIG. 5. In this Figure, three of the drawing blocks 500a-c are aligned left. In other words, the drawing blocks have a common anchor at the left edge 32. The fourth block 500d is not aligned as its edge 32d is not in alignment with the common anchors at the left edge 32 of the other drawing blocks 500a-c. The user wishes to align all of the drawing blocks 500a-d and selects the drawing blocks 500a-d and instructs the graphical processor 160 to align the drawing blocks 500a-d. The graphical processor 160 knows the common element (left edge 32) and thus merely needs to recalculate the position of the drawing block 500d to produce the aligned drawing blocks 500a-d, as is shown by the arrow.

### Command Matching

In a further use case, the common elements of the anchors can be used to move a drawing block to a desired position in the slide 20. For example, it is known that the left, right, up and down keys on a keyboard can be used to move a selected drawing block to another position defined by the key pressed. In the Microsoft Power Point program, for example, pressing the left key move the selected drawing block a small distance to the left. In the prior art, this pressing of the left key needs to be repeated until the drawing block is in a correct position.

The apparatus and method of the current document allow a more efficient method of placement of the drawing block. This is done by using a keyboard short cut to move a selected one of the drawing blocks automatically to the anchor on the slide 20 in a direction indicated by one of the left, right, up, and down keys on a keyboard. In other words, using the keyboard short cut would not move the drawing block a pre-defined distance, but the graphical processor 160 would obtain a signal from the keyboard, due to the depression of the keys, indicating the direction of movement and then identify an appropriate one of the anchors in that direction and move the drawing block to the identified appropriate anchor such that the anchor of the drawing block is matched to that appropriate anchor. In other words, the graphical processor 160 does not need to continually render the slide 20 on the display 180 whilst the direction key is repeatedly pushed but needs only to refresh the display 180 once after depression of the direction key. This is shown in FIG. 8 in which the drawing block 90 is moved from a first anchor position 85 to a second anchor position 80 by depression of the left key on the keyboard. The coordinates of the drawing block 90 will be exchanged and the new image rendered.

### Text Wrapping

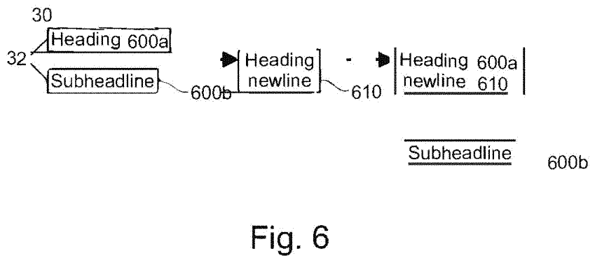

The apparatus and method enable automatic arrangement of the drawing blocks when text is added to one of the drawing blocks and this drawing blocks expands to overlap another drawing block, as shown in FIG. 6. In this example, the anchor points of the two drawing blocks 600a and 600b have a common element (left edge 32). A new line “newline” 610 is added to the drawing block 600a and it can be seen in the middle diagram that the formatting of the drawing block 600a leads to the block 600a overlapping the block 600b. The block 600b is moved down, as shown in the right-hand diagram, and this common element (left edge 32) is maintained as the overlapped drawing block 600b is repositioned to prevent the overlapping text. This enables a repositioning of the overlapped drawing block 600b efficiently by avoiding the need for the user to manually drag the overlapped drawing block 600b, which is inefficient in terms of use of computer resources as previously explained.

### Grouping

In a further aspect, grouping of a plurality of the drawing blocks can be carried out by selecting all of the blocks with a common anchor.

### REFERENCE NUMERALS

10 User interface
20 Slide
22-25 Margins
26 Center horizontal
27 Center vertical
30 Drawing block
32 Left edge
33 Right edge
34 Top edge
35 Bottom edge
36 Center horizontal
37 Center vertical
40 Anchor elements
100 System
110 Server
120 Processor
130 Program
140 Network
150 Client computers
155 Local processor
160 Graphical processor
170 Graphics memory
180 Display unit
500a-d Drawing blocks

1. A computer-implemented method of re-ordering one or more of a plurality of drawing blocks on a slide of a user interface canvas, wherein the user interface canvas is stored as memory elements in a graphics memory, the method comprising:
analyzing, using a graphical processor, the memory elements in the graphics memory to identify a plurality of anchor positions for the plurality of drawing blocks and for the slide-;
storing the identified anchor positions in the graphics memory;
analyzing the identified and stored anchor positions to identify common elements from among the identified and stored anchor positions, whereby said identified common elements are stored in the graphics memory; and
reordering at least one of the drawing blocks to a different position on the slide such that at least one of the anchor positions of the re-ordered drawing block moves to one of the identified common elements.

2. The computer-implemented method of claim 1, wherein the anchor positions comprises at least one of a left edge, a right edge, a top edge, a bottom edge, a vertical center or a horizontal center.

3. The computer-implemented method of claim 1, further comprising identification of similar ones of the drawing blocks from the identified common elements.

4. The computer-implemented method of claim 1 further comprising highlighting the similar ones of the drawing blocks on a display device.

5. The computer-implemented method of claim 1 further comprising grouping a plurality of the drawing blocks sharing the common element.

6. An apparatus for re-ordering drawing blocks on a slide of a user interface canvas, the apparatus comprising a graphics memory, a display device, and a graphical processor for performing the method of claim 1.

7. A computer program product of re-ordering one or more of a plurality of drawing blocks on a slide of a user interface canvas, the computer program product being stored on a non-volatile storage means and comprising:
first logic means for analyzing using a graphical processor memory elements in the graphics memory to identify a plurality of anchor positions for the drawing blocks and the slide;
second logic means for storing the identified anchor positions in the graphics memory;
third logic means for analyzing the identified and stored anchor positions to identify common elements from among the identified and stored anchor positions; and
fourth logic means for reordering at least one of the drawing blocks to a different position on the slide such that at least one of the anchor positions of the re-ordered drawing block moves to a common element.
